(19) United States
(12) Patent Application Publication
(10) Pub. No.: US 2011/0027486 A1
(43) Pub. Date: Feb. 3, 2011

(54) Method for preparing transmission electron microscope sample

(75) Inventors: Kai-Li Jiang, Beijing (CN); Li-Na Zhang, Beijing (CN); Hao-Xu Zhang, Beijing (CN); Shou-Shan Fan, Beijing (CN)

Correspondence Address: Altis Law Group, Inc.;ATTN: Steven Reiss, 288 SOUTH MAYO AVENUE, CITY OF INDUSTRY, CA, 91789, US

(73) Assignees: Tsinghua University, Beijing City (CN); HON HAI Precision Industry CO., LTD., Tu-Cheng City (TW)

(21) Appl. No.: 12/590,664

(22) Filed: Nov. 12, 2009

(30) Foreign Application Priority Data
Jul. 31, 2009 (CN) 200910108864.4

(51) Int. Cl. B05D 3/00

(52) U.S. Cl. 427/331

(57) ABSTRACT

The present invention relates to a method for preparing a transmission electron microscope sample. An amount of nano-scale specimens and an amount of graphene sheets are dispersed into a solvent, thereby achieving a dispersed solution. A transmission electron microscope grid including a carbon nanotube film structure is provided. A portion of the carbon nanotube film structure is suspended. The dispersed solution is applied on the carbon nanotube film structure. The solvent in the carbon nanotube structure is removed.

### RELATED APPLICATIONS

This application claims all benefits accruing under 35 U.S.C. §119 from China Patent Application No. 200910108864.4, filed on Jul. 31, 2009 in the China Intellectual Property Office, the disclosure of which is incorporated herein by reference. This application is related to commonly-assigned application entitled, “CARBON NANOTUBE FILM COMPOSITE STRUCTURE, TRANSMISSION ELECTRON MICROSCOPE GRID USING THE SAME, AND METHOD FOR MAKING THE SAME”, filed ______ (Atty. Docket No. US25891).

### BACKGROUND

1. Technical Field

The present disclosure relates to a method for preparing a transmission electron microscope sample.

2. Description of Related Art

Transmission electron microscopy is one of the most important techniques available for the detailed examination and analysis of small materials. The specimen to be analyzed can be in a powder form. Before analyzing the powder using transmission electron microscopy, a transmission electron microscope (TEM) sample should be prepared. The TEM sample can include a TEM grid, and the specimen supported by the TEM grid. A conventional method for preparing the TEM sample includes the steps of: dispersing a specimen in a solvent such as ethanol, to form a dispersed solution; placing drops of the dispersed solution on the top surface of the TEM grid; and drying the solution leaving a deposit of the specimen on the surface. In prior art, the TEM grid includes a metal grid such as a copper or nickel grid, a porous organic membrane covering the metal grid, and an amorphous carbon film deposited on the porous organic membrane. In the TEM sample, the powder specimen is supported directly by the amorphous carbon film. However, in practical application, when the powder particles corresponds to or is less than the thickness of the supporting film, the amorphous carbon film induces a high noise in the transmission electron microscopy imaging.

What is needed, therefore, is a method for preparing a TEM sample to achieve higher resolution transmission electron microscopy images when the specimen is nano in scale.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a flow chart of an embodiment of a method for preparing a TEM sample.

FIG. 2 shows a Scanning Electron Microscope (SEM) image of a carbon nanotube film.

FIG. 3 is a schematic view of the TEM sample prepared by the method of FIG. 1.

FIG. 4 shows an SEM image of a carbon nanotube film structure including at least two stacked carbon nanotube films of FIG. 2, aligned along different directions.

FIG. 5 is a partial schematic view of the TEM sample of FIG. 3.

FIG. 6 shows a TEM image of a graphene sheet covering a carbon nanotube film structure.

FIG. 7 shows a TEM image of nano-scale gold particles using the TEM sample of FIG. 3.

FIG. 8 shows a high resolution TEM image of the nano-scale gold particles using the TEM sample of FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

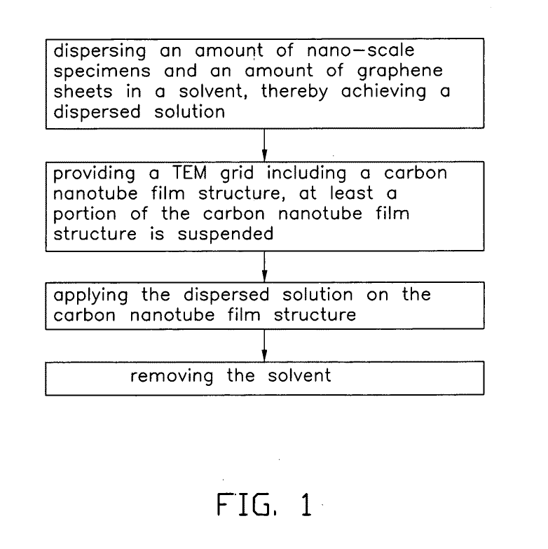

Referring to FIG. 1, a method for making a TEM sample in one embodiment includes:
(a) dispersing an amount of nano-scale specimens and an amount of graphene sheets in a solvent, thereby achieving a dispersed solution;
(b) providing a TEM grid including a carbon nanotube film structure, a portion of the carbon nanotube film structure being suspended;
(c) applying the dispersed solution on the carbon nanotube film structure; and
(d) removing the solvent.

In step (a), the dispersed solution is obtained by a method including: (a11) providing an amount of graphene sheets, an amount of nano-scale specimens, and a solvent; (a22) disposing the graphene sheets and the nano-scale specimens in the solvent to form a mixture; (a23) ultrasonically agitating the mixture to uniformly disperse and/or suspend the graphene sheets and the nano-scale specimens in the solvent, thereby achieving the dispersed solution. In one embodiment, the mixture is ultrasonically agitated for about 15 minutes. It is to be understood that other methods can be used to disperse the graphene sheets and the nano-scale specimens in the solvent. For example, the mixture can be stirred mechanically.

The solvent in the dispersed solution should be able to allow dispersion of the graphene sheets and the nano-scale specimens and be able to be evaporated totally. Ingredients of the solvent can have a small molecular weight. In one embodiment, the solvent can be selected from the group consisting of water, ethanol, methanol, acetone, dichloroethane, chloroform, and combinations thereof. In one embodiment, the solvent is water. It is to be understood that, the solvent only acts as a medium wherein the graphene sheets and the nano-scale specimens are dispersed, and thus, the solvent should not react with the graphene sheets and the nano-scale specimens. The graphene sheets and the nano-scale specimens should not have a chemical reaction with the solvent, or be dissolved in the solvent.

The nano-scale specimens 200 can be nanowires, nanotubes, nanoballs, and so on. The size of a single nano-scale specimen 200 can be smaller than 1 micron. In one embodiment, the size of the single nano-scale specimen 200 can be smaller than 10 nanometers. A concentration of the nano-scale specimens in the dispersed solution can be equal to or less than 5% (volume/volume).

The graphene sheet can be a single layer of graphene or multi-layer of graphene. In one embodiment, the graphene sheet includes 1 to 3 layers of graphene, thus enabling better contrast TEM imaging. The graphene is a one-atom-thick planar sheet of sp²-bonded carbon atoms that are densely packed in a honeycomb crystal lattice. The size of the graphene sheet can be very large (e.g., several millimeters). Generally, the size of the graphene sheet is less than about 10 microns (e.g., less than 1 micron). It is to be understood that, the graphene sheet and the pore in the carbon nanotube film structure are rectangle or polygon in shape. The size of the graphene sheet is defined by the maximum linear distance between one point to another point both on the edge of the graphene sheet. The size of the pore is defined by the maximum distance between two points on the pore. The concentration of the graphene sheets in the dispersed solution is less than about 5% (volume/volume). The concentration of the nano-scale specimens is smaller than the concentration of the graphene sheets in the dispersed solution.

In step (b), the TEM grid can be fabricated by a method including: (b1) providing a grid and at least two carbon nanotube films, the carbon nanotube film can be drawn from a carbon nanotube array; (b2) forming the carbon nanotube film structure on the grid by using the at least two carbon nanotube films, wherein a plurality of pores are defined in the carbon nanotube film structure, thereby achieving the TEM grid; and (b3) treating the TEM grid with an organic solvent, to soak the carbon nanotube film structure by the organic solvent.

In step (b1), the carbon nanotubes in the carbon nanotube film are aligned substantially along the same direction.

A method for making the carbon nanotube film includes steps of: (b11) providing the carbon nanotube array capable of having a film drawn therefrom; and (b12) pulling/drawing out the carbon nanotube film from the carbon nanotube array. The pulling/drawing can be done by using a tool (e.g., adhesive tape, pliers, tweezers, or another tool allowing multiple carbon nanotubes to be gripped and pulled simultaneously).

In step (b11), a given carbon nanotube array can be formed by a chemical vapor deposition (CVD) method. The carbon nanotube array includes a plurality of carbon nanotubes parallel to each other and approximately perpendicular to the substrate. The carbon nanotubes in the carbon nanotube array are closely packed together by van der Waals attractive force. The carbon nanotubes in the carbon nanotube array can be single-walled carbon nanotubes, double-walled carbon nanotubes, multi-walled carbon nanotubes, or combinations thereof. The diameter of the carbon nanotubes can be in the range from about 0.5 nanometers to about 50 nanometers. The height of the carbon nanotubes can be in the range from about 50 nanometers to about 5 millimeters. In one embodiment, the height of the carbon nanotubes can be in a range from about 100 microns to about 900 microns.

In step (b12), the carbon nanotube film includes a plurality of carbon nanotubes, and there are interspaces between adjacent two carbon nanotubes. Carbon nanotubes in the carbon nanotube film can be parallel to a surface of the carbon nanotube film. A distance between adjacent two carbon nanotubes can be larger than a diameter of the carbon nanotubes. The carbon nanotube film can be pulled/drawn by the following substeps: (b121) selecting a carbon nanotube segment having a predetermined width from the carbon nanotube array; and (b122) pulling the carbon nanotube segment at an even/uniform speed to achieve a uniform drawn carbon nanotube film.

In step (b121), the carbon nanotube segment having a predetermined width can be selected by using an adhesive tape such as the tool to contact the carbon nanotube array. The carbon nanotube segment includes a plurality of carbon nanotubes parallel to each other. In step (b122), the pulling direction is arbitrary (e.g., substantially perpendicular to the growing direction of the carbon nanotube array).

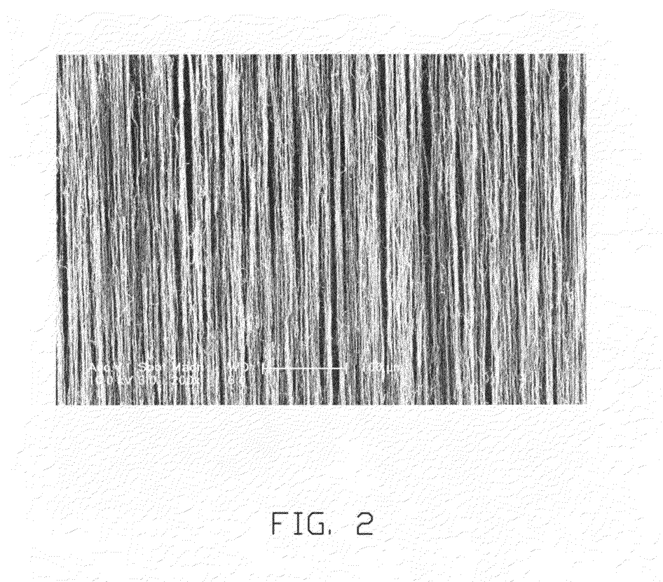

More specifically, during the pulling process, as the initial carbon nanotube segment is drawn out, other carbon nanotube segments are also drawn out end-to-end due to the van der Waals attractive force between ends of adjacent segments. This process of drawing ensures that a continuous, uniform carbon nanotube film having a predetermined width can be formed. Referring to FIG. 2, the carbon nanotube film includes a plurality of carbon nanotubes joined end-to-end. The carbon nanotubes in the carbon nanotube film are parallel to the pulling/drawing direction of the drawn carbon nanotube film, and the carbon nanotube film produced in such manner can be selectively formed to have a predetermined width. The carbon nanotubes in the carbon nanotube film are joined end-to-end by van der Waals attractive force therebetween to form a free-standing film. The term ‘free-standing’ includes, but is not limited to, structures that do not have to be supported by a substrate. The adjacent two carbon nanotubes side by side may be in contact with each other or spaced apart from each other. A small clearance can be defined by the adjacent two carbon nanotubes side by side which are spaced apart from each other.

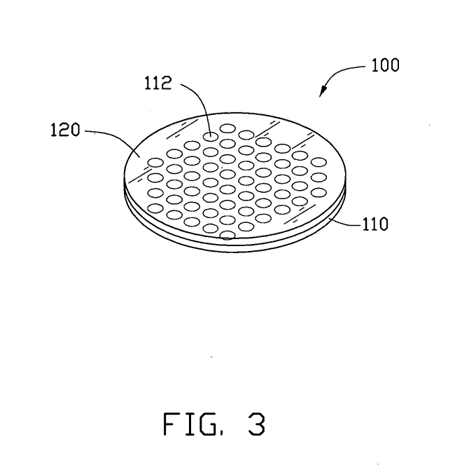

In step (b2), referring to FIG. 3, the grid 110 has at least one through hole 112. The carbon nanotube film structure 120 covers the through hole 112, and is suspended across the through hole 112. The grid 110 can be a sheet with one or more through holes 112 therein. The grid 110 can be used in the conventional TEM grid. The material of the grid 110 can be metal or other suitable materials such as ceramics and silicon. In one embodiment, the material of the grid 110 is copper.

The carbon nanotube film structure 120 includes at least two stacked carbon nanotube films aligned along different directions. An aligned direction of the carbon nanotube film is defined by the orientation of the majority of the carbon nanotubes in the carbon nanotube film. In the carbon nanotube film structure 120, the carbon nanotubes in different carbon nanotube films can intersect with each other. The carbon nanotube film is free standing, and thus, the carbon nanotube film structure 120 is also a free-standing structure.

The carbon nanotube film structure 120 is placed on the grid 110, thereby suspending portions of the carbon nanotube film structure 120 across the through holes 112. In one embodiment, the carbon nanotube film structure 120 is equal in size to the grid 110, and covers the entire surface of the grid 110. The through hole 112 has a diameter larger than the size of the pores 126 in the carbon nanotube film structure 122, and larger than the size of the graphene sheet 124. In one embodiment, the diameter of the through hole 112 is in the range from about 10 microns to about 2 millimeters.

Two or more carbon nanotube films can be stacked on the grid 110 to form the carbon nanotube film structure 120. In one embodiment, in the carbon nanotube film structure 120, every carbon nanotube film can be respectively aligned along different directions. In another embodiment, more than two carbon nanotube films can be divided into two or more groups. The carbon nanotube films in the same group can be aligned along the same direction, and the carbon nanotube films in different groups are aligned along different directions.

In the carbon nanotube film structure 120, an angle α exists between the orientation of carbon nanotubes in the two carbon nanotube films aligned along different directions. Adjacent carbon nanotube films can be combined only by the van der Waals attractive force therebetween and a more stable carbon nanotube film structure 120 is formed. The number of the carbon nanotube films in the carbon nanotube film structure 120 is not limited. In one embodiment, the carbon nanotube film structure 120 consists of 2 to 4 layers of carbon nanotube films. The angle α between the orientations of carbon nanotubes in the two carbon nanotube films aligned along different directions can be larger than 0 degrees. In one embodiment, the angle α is about 90 degrees.

In one embodiment, to form the grid 110 with the carbon nanotube film structure 120 thereon, the at least two carbon nanotube films can be covered on the grid 110, and aligned along different directions. More specifically, the first carbon nanotube film is covered on the grid 110 along one direction, and the second carbon nanotube film is covered on the first carbon nanotube film along another direction. By using the same manner, more than two carbon nanotube films can be stacked with each other on the grid 110.

In another embodiment, to form the grid 110 with the carbon nanotube film structure 120 thereon, a frame can be provided, and a first carbon nanotube film can be secured on the frame. One or more edges of the carbon nanotube film are attached on the frame, and other part of the carbon nanotube film is suspended. A second carbon nanotube film can be placed on the first carbon nanotube film along another direction. By using the same manner, more than two carbon nanotube films can be stacked with each other on the frame. The carbon nanotube films can respectively aligned along different directions, and can also just aligned along two directions. The carbon nanotube film structure 120 can be moved from the frame to cover the surface of the grid 110.

In step (b3), the carbon nanotube film structure 120 covered on the grid 110 is treated with an organic solvent, to better adhere the carbon nanotube film structure 120 with the grid 110 tightly. After being treated by the organic solvent, the contacting area of the carbon nanotube film structure 120 with the grid will increase, and thus, the carbon nanotube film structure 120 will more firmly adhere to the surface of the grid 110. The organic solvent can be volatile at room temperature, and can be ethanol, methanol, acetone, dichloroethane, chloroform, or any combination thereof. In one embodiment, the organic solvent is ethanol. The organic solvent should have a desirable wettability relative to the carbon nanotubes. More specifically, the step (b3) can include a step of applying the organic solvent on the surface of the carbon nanotube film structure 120 by using a dropper; or a step of immersing the entire carbon nanotube film structure 120 into a container with the organic solvent therein. By treating with the organic solvent, the carbon nanotube film structure 120 can be firmly attached on the grid 110. More specifically, part of the carbon nanotubes in the untreated carbon nanotube film that do not touch the grid 110 will come into contact with the grid 110 after the organic solvent treatment due to the surface tension of the organic solvent. Then the contacting area of the carbon nanotube film structure 120 with the grid 110 will increase, and thus, the carbon nanotube film structure 120 can firmly adhere to the grid 110.

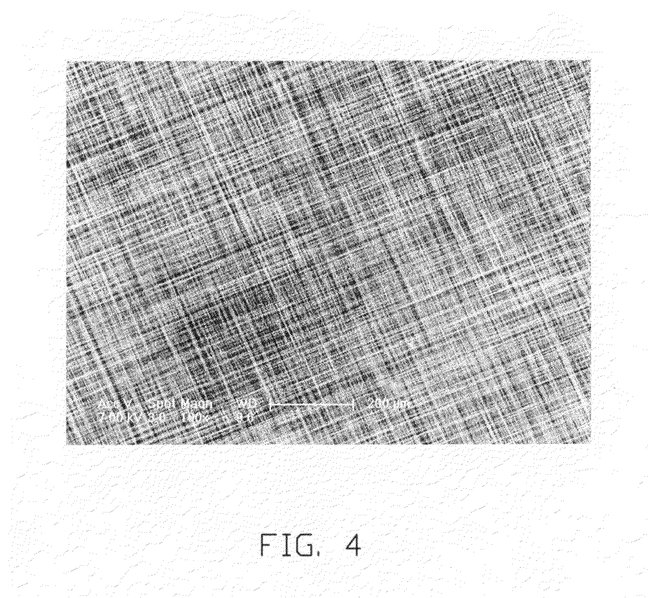

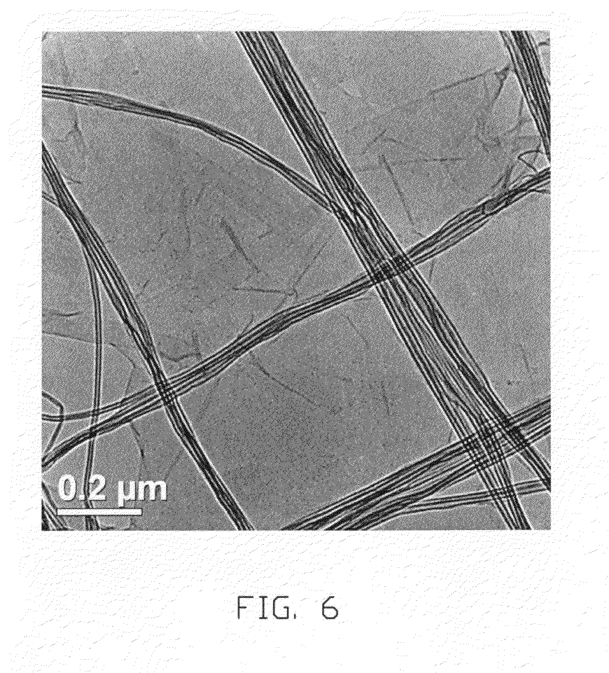

After an organic solvent is applied to the carbon nanotube film structure 120, the organic solvent can be evaporated from the carbon nanotube film structure 120. The removal of the organic solvent will enlarge the clearances defined between adjacent carbon nanotubes thereby forming and/or increasing the size of a plurality of pores in the carbon nanotube film structure 120. Referring to FIG. 4 and FIG. 6, after the organic solvent is evaporated, the adjacent parallel carbon nanotubes in the carbon nanotube film will bundle together, due to the surface tension of the organic solvent when the organic solvent volatilizing. The bundling will create parallel and spaced carbon nanotube strings. Due to the edges of the carbon nanotube film structure 120 being secured by the frame or other holder such as the grid 110, the bundling can only occur in microscopic view, and the carbon nanotube film structure 120 will substantially maintain its shape in macroscopic view. The carbon nanotube strings also include a plurality of carbon nanotubes joined end-to-end by Van der Waals attractive force therebetween. Due to the carbon nanotube films being aligned along different directions, the carbon nanotube strings formed from carbon nanotubes in different carbon nanotube films intersect with each other and define a plurality of pores. The angle α existed between the orientation of the intercrossed carbon nanotube strings is in the range of 0°≦α≦90°. In one embodiment, a is equal to about 90 degree.

The size of the pore is ranged from about 1 nanometer to about 10 microns. In one embodiment, the size of the pore ranges from about 1 nanometer to about 900 nanometers. In one embodiment, the carbon nanotube film structure 120 consists of 4 layers of carbon nanotube films, and above 60% of the pores are nano in scale. It is to be noted that, the more the layers of carbon nanotube films, the smaller the size of the pores in the carbon nanotube film structure 120. Thus, by adjusting the number of the carbon nanotube films in the carbon nanotube structure 120, the desired size of the pores can be achieved. It is to be understood that, the step of treating the carbon nanotube film structure 120 with the organic solvent is optional. Additionally, the result can be accomplished by having the solvent in the dispersed solution be an acceptable organic solvent.

It is to be understood that, the carbon nanotube film directly drawn from the carbon nanotube array has a large area, and an optional step of removing the excess portion of the carbon nanotube film structure 120 outside the grid along the edge of the grid can be performed. The excess portion of the carbon nanotube film structure 120 outside the grid 110 can be further removed by using a laser beam focused on the excess portion, to burn away the excess carbon nanotubes. In one embodiment, the laser beam has a power of 5 W to 30 W (e.g., 18 W).

In step (c), the dispersed solution can be applied on the surface of the carbon nanotube film structure 120 to soak the surface thereof. In other embodiments, the grid 110 with the carbon nanotube film structure 120 thereon can be immersed in the dispersed solution, and then removed from the dispersed solution. It is noted that, when the solvent in the dispersed solution is volatile organic solvent, the step (c) also can form pores in the carbon nanotube film structure 120, and more firmly secure the carbon nanotube film structure 120 to the grid 110. Thus, the step (b3) can be omitted.

In step (d), the solvent is removed. This can be done actively or passively. In one embodiment, the grid 110 with the carbon nanotube film structure 120 thereon can be disposed in room temperature for a period of time, to totally evaporate the solvent in the carbon nanotube film structure 120. In a different embodiment, the grid 110 can be disposed in an oven at an elevated temperature to dry the solvent. The temperature can be in a range from 40° C. to 100° C. Once solvent is totally evaporated, the graphene sheets and the nano-scale specimens are left on the surface of the carbon nanotube film structure. Other impurities should be prevented from being introduced in the TEM sample 100.

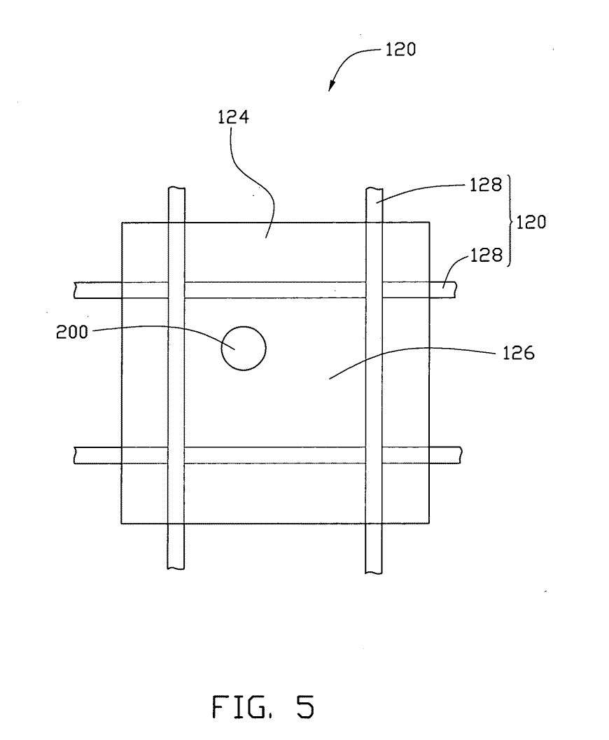

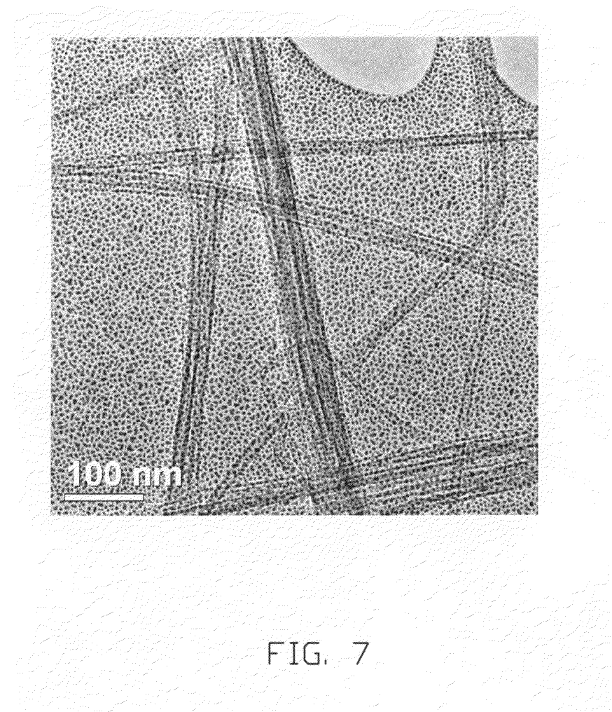

After the solvent is evaporated, the graphene sheets and the nano-scale specimens are uniformly disposed on the surface of the carbon nanotube film structure 120. Referring to FIG. 5, at least one graphene sheet 124 is covered on at least one pore 126 defined by the intercrossed carbon nanotube strings 128 in the carbon nanotube film structure 120. The specimens 200 are disposed on the surface of the graphene sheet 124 covered the pore 126 of the carbon nanotube film structure 120. The carbon nanotube film structure 120 includes a plurality of carbon nanotube strings 128 intercrossed with each other. The carbon nanotube string 128 comprises paralleled carbon nanotubes. More specially, the carbon nanotube string 128 comprises a plurality of carbon nanotubes joined end-to-end and side by side by van der Waals attractive force therebetween. A plurality of pores 126 are defined by the intercrossed carbon nanotube strings 128, in the carbon nanotube film structure 120. It is to be understood that, in the TEM sample 100, at least one pore 126 is covered by at least one a graphene sheet 124, and at least one nano-scale specimen 200 is supported by the graphene sheet 124. This is ensured by adjusting the concentration of the graphene sheets 124 and the nano-scale specimens 200 in the solvent, and the amount of the dispersed solution placed on the TEM grid. For example, the dispersed solution can be applied to the carbon nanotube film structure 120 many times, to allow more specimens 200 placed on the TEM grid. Referring to FIG. 7, it is to be understood that, when the size of the nano-scale specimens 200 is much smaller than the size of the pores 126, a large amount of nano-scale specimens 200 can be uniformly distributed on the surface of the graphene sheet 124, and the TEM photo can be used to analyze the size distribution of the nano-scale specimens 200, and observing the self-assembling of the large amount of nano-scale specimens 200 on the surface of the graphene sheet 124.

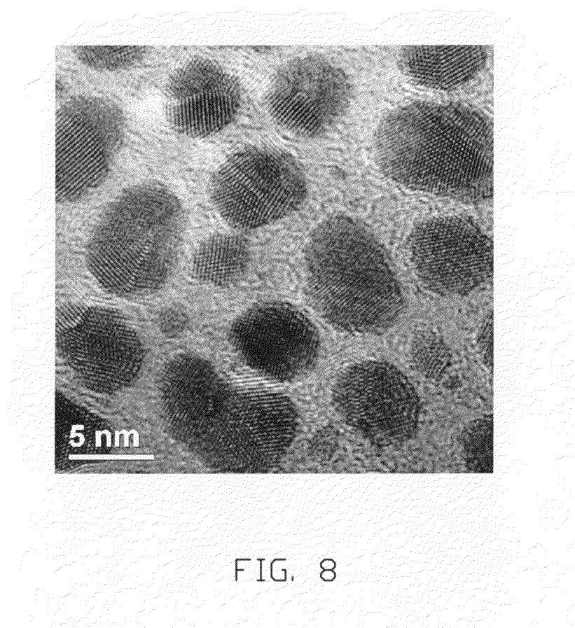

Referring to FIGS. 7 and 8, the nano-scale specimens 200 are an amount of nano-scale gold powder, which are shown as the black spots in figures. The nano-scale gold powder has relatively high resolution in the TEM photos.

The method for preparing the TEM sample 100 has at least the following advantages. Firstly, the graphene sheet 124 has an extremely small thickness. The graphene has a thickness of about 0.335 nanometers. Therefore, the background noise during the TEM observation can be lowered, and TEM photos having higher resolution can be achieved. Secondly, a graphene sheet 124 with a larger size, and a through hole 112 of a grid 110 with smaller diameter are both difficult to be formed. The carbon nanotube film structure 120 having a plurality of pores 126 is used as a framework to support the graphene sheets 124 thereon, thereby suspending the graphene sheets 124 on the TEM sample 100. Thirdly, due to a high purity of the carbon nanotube film drawn from the carbon nanotube array, before application, the TEM sample 100 including the carbon nanotube films do not require elimination of impurities by using a thermal treatment.

It is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

It is also to be understood that the above description and the claims drawn to a method may include some indication in reference to certain steps. However, the indication used is only to be viewed for identification purposes and not as a suggestion as to an order for the steps.

What is claimed is:

1. A method for preparing a transmission electron microscope sample comprising steps of:
dispersing an amount of nano-scale specimens and an amount of graphene sheets into a solvent, thereby achieving a dispersed solution;
providing a transmission electron microscope grid comprising a carbon nanotube film structure, wherein at least a portion of the carbon nanotube film structure is suspended;
applying the dispersed solution on the carbon nanotube film structure; and
removing the solvent.

2. The method of claim 1, wherein a volume percentage of the nano-scale specimens in the dispersed solution ≦5%.

3. The method of claim 1, wherein a volume percentage of the graphene sheets in the dispersed solution ≦5%.

4. The method of claim 1, wherein a volume percentage of the graphene sheets is greater than a volume percentage of the nano-scale specimens.

5. The method of claim 1, wherein the solvent comprises of a material that is selected from the group consisting of water, ethanol, methanol, acetone, dichloroethane, chloroform, and combinations thereof.

6. The method of claim 1, wherein a method for making the transmission electron microscope grid comprises steps of:
providing a grid and a carbon nanotube structure disposed on the grid; wherein the carbon nanotube structure comprises of at least two carbon nanotube films, and a plurality of pores are defined in the carbon nanotube film structure.

7. The method of claim 6, wherein the carbon nanotube film is drawn from a carbon nanotube array.

8. The method of claim 6, wherein the at least two carbon nanotube films are stacked and aligned along different directions.

9. The method of claim 8, wherein the at least two carbon nanotube films are aligned perpendicularly to each other.

10. The method of claim 6, wherein the at least two carbon nanotube films are attached on a frame and aligned along different directions to form the carbon nanotube film structure, and the carbon nanotube film structure is moved from the frame to cover the grid.

11. The method of claim 6, wherein a number of the at least two carbon nanotube films is in a range from 2 to 4.

12. The method of claim 6, wherein the method for making the transmission electron microscope grid further comprises a step of applying organic solvent to the carbon nanotube film structure.

13. The method of claim 12, wherein the organic solvent comprise of a material that is selected from the group consisting of ethanol, methanol, acetone, dichloroethane, chloroform, and combinations thereof.

14. The method of claim 12, wherein the organic solvent is applied to the surface of the carbon nanotube film structure.

15. The method of claim 12, wherein the entire carbon nanotube film structure is immersed into a container having the organic solvent therein.

16. The method of claim 6, wherein the method for making the transmission electron microscope grid further comprises a step of removing any excess portion of the carbon nanotube film structure.

17. The method of claim 1, wherein the dispersed solution is applied to the surface of the carbon nanotube film structure.

18. The method of claim 1, wherein the entire carbon nanotube film structure is immersed into a container having the dispersed solution therein.

19. The method of claim 1, wherein the solvent is removed at an elevated temperature.

20. The method of claim 1, wherein the carbon nanotube film structure comprises of a plurality of pores, and at least one of the plurality of pores is covered by a graphene sheet.
